(19) United States
(12) Patent Application Publication
(10) Pub. No.: US 2023/0402695 A1
(43) Pub. Date: Dec. 14, 2023

(54) MULTILAYER, FLEXIBLE, IMPACT AND PUNCTURE RESISTANT, FLUID IMPERVIOUS, DIELECTRIC INSULATOR SHEET FOR AN ELECTRIC VEHICLE BATTERY PACK AND MOUNTING ARRANGEMENT THEREWITH

(71) Applicants: FEDERAL-MOGUL POWERTRAIN LLC, NORTHVILLE, MI (US); NISSAN MOTOR CO., LTD., KANAGAWA (JP)

(72) Inventors: Kazuhiko Baba, Kanagawa Prefecture SP (JP); Kazuto Kitagawa, Kanagawa Prefecture SP (JP); Tetsuaki Ogawa, Kanagawa Prefecture SP (JP); Naoto Todoroki, Kanagawa (JP); Shunsuke Arima, Kanagawa (JP); Yukiko Kinoshita, Kanagawa (JP); Kentaro Hatta, Kanagawa (JP)

(21) Appl. No.: 18/332,900

(22) Filed: Jun. 12, 2023

Related U.S. Application Data
(60) Provisional application No. 63/351,616, filed on Jun. 13, 2022.

(51) Int. Cl. H01M 50/242; H01M 50/249; H01M 50/262; H01M 50/231; H01M 50/227; D03D 15/283; D03D 15/292; D03D 1/00; D03D 15/49; B32B 27/12; B32B 27/36; B32B 5/02; B60L 50/64

(52) U.S. Cl. CPC H01M 50/242; H01M 50/249; H01M 50/262; H01M 50/231; H01M 50/227; D03D 15/283; D03D 15/292; D03D 1/00; D03D 15/49; B32B 27/12; B32B 27/36; B32B 5/024; B60L 50/64; H01M 2220/20; D10B 2331/02; D10B 2401/06; D10B 2505/12; B32B 2457/10; B32B 2605/00; B32B 2307/7265; B32B 2307/7376; B32B 2307/204; B32B 2307/546; B32B 2307/58; B32B 2307/558; B32B 2262/0261; B32B 2457/04

(57) ABSTRACT

A multilayer, flexible, impact and puncture resistant, impervious, dielectric insulator sheet and mounting arrangement therewith for an electric vehicle battery pack includes a textile layer having generally planar opposite first and second sides and a fluid impervious film fixed to the first side with an adhesive laminate. The adhesive laminate includes a polymeric film sandwiched between opposite first and second layers of adhesive material. The first layer of adhesive material is bonded to the textile layer and the second layer of adhesive material is bonded to the fluid impervious film.

### CROSS-REFERENCE TO RELATED APPLICATION

This application claims the benefit of U.S. Provisional Application Ser. No. 63/351,616, filed Jun. 13, 2022, which is incorporated herein by reference in its entirety.

### BACKGROUND OF THE INVENTION

### 1. Technical Field

This invention relates generally to electric vehicle batter packs, and more particularly to a multilayer material having impact resistant, fluid impervious, electrically insulative properties for inhibiting a short-circuit of a battery pack of an electric vehicle upon a force impacting a connector of a battery pack.

### 2. Related Art

It is known to contain or shield cells 1 of a battery pack 2, including those used in electric vehicle applications, in a polymeric battery case 3 (FIGS. 6A and 6B). It is further known to secure the battery case 3 to a vehicle frame or body panel 6 of the electric vehicle via at least one metal mount bracket 4 and fastener 5. Although such fixation mechanism is useful for fixing the battery pack 2 to the body panel 6, further developments are desired. As shown in FIG. 6C, it is desired to prevent an impact force F from damaging the batter pack 2 in such a manner as to cause a short-circuit within the battery pack 2. In the illustrated example, the impact force F is shown deforming the body panel 6, which in turn has caused the metal mount bracket 4 to penetrate, also referred to as puncture or pierce, a polymeric battery cover 7. Upon penetrating the battery cover 7, the metal mount bracket 4 is shown contacting, or coming into close proximity, a conductive bus bar 8 interconnecting the cells 1 in electrical communication with one another, whereupon a short-circuit can be established between the metal mount bracket 4 and the cells 1. The development of a short-circuit can be further promoted by the presence of any conductive fluid/moisture, including water and/or water vapor, which is typically present in a high humidity environment.

Accordingly, it is desired to provide a battery pack assembly that is resistant to short-circuiting upon encountering an impact force, such as to a mount bracket used to secure the battery pack to a body frame/panel of an electric or electric/hybrid vehicle.

### SUMMARY OF THE INVENTION

It is an object of the present disclosure to provide a multilayer material for use with an electric vehicle battery pack that addresses at least those issues discussed above.

It is a further object of the present disclosure to provide a multilayer material for use in a mounting arrangement of an electric vehicle battery pack that addresses at least those issues discussed above.

It is a further object of the present disclosure to provide a multilayer material for use in a mounting arrangement of an electric vehicle battery pack, wherein the multilayer material is impervious to the passage of fluid therethrough to inhibit the onset of a short-circuit between the mounting arrangement and the battery pack.

It is a further object of the present disclosure to provide a multilayer material for use in a mounting arrangement of an electric vehicle battery pack that is multifunctional and customizable in size and shape, so as to be adaptable for use in wise variety of battery pack/mounting arrangement configurations.

It is a further object of the present disclosure to provide a multilayer material for use in a mounting arrangement of an electric vehicle battery pack that is tough and puncture resistant.

It is a further object of the present disclosure to provide a multilayer material for use in a mounting arrangement of an electric vehicle battery pack that is economical in manufacture and assembly.

One aspect of the invention provides a multilayer, flexible, impact and puncture resistant, impervious, dielectric insulator sheet for an electric vehicle battery pack. The insulator sheet includes a textile layer having generally planar opposite first and second sides and a fluid impervious film fixed to the first side. The fluid impervious film is fixed to the first side with an adhesive layer.

Another aspect of the invention provides a multilayer, flexible, impact resistant, impervious, dielectric insulator sheet for a mounting arrangement of an electric vehicle battery pack. The insulator sheet includes a textile layer having generally planar opposite first and second sides and a fluid impervious film fixed to the first side. The fluid impervious film is fixed to the first side with an adhesive layer.

In accordance with another aspect of the disclosure, the adhesive layer is can be provided as an adhesive laminate including a polymeric film sandwiched between opposite layers of adhesive material, wherein one of the opposite layers of adhesive material is bonded to the textile layer and the other of the opposite layers of adhesive material is bonded to the fluid impervious film.

In accordance with another aspect of the disclosure, the fluid impervious film can be provided as a polymeric film.

In accordance with another aspect of the disclosure, the polymeric film can be provided as a polyethylene terephthalate film.

In accordance with another aspect of the disclosure, the polyethylene terephthalate film has a gauge between 200-1000.

In accordance with another aspect of the disclosure, the polyethylene terephthalate film has a dielectric resistance between 5 kV-25 kV.

In accordance with another aspect of the disclosure, the textile layer can be formed as a woven layer.

In accordance with another aspect of the disclosure, the woven layer is woven including weft direction multifilament yarn and warp direction multifilament yarn.

In accordance with another aspect of the disclosure, the weft direction multifilament yarn has a denier between 1400 and 2300, and the warp direction multifilament yarn has a denier between 2400 and 3400.

In accordance with another aspect of the disclosure, the weft direction multifilament yarn is air texturized, and the warp direction multifilament yarn is air texturized and twisted.

In accordance with another aspect of the disclosure, the woven layer is woven with a densely woven plain weave pattern.

In accordance with another aspect of the disclosure, the weft direction multifilament yarn and the warp direction multifilament yarn can be provided as polyamide 6.

In accordance with another aspect of the disclosure, the impervious insulator sheet can further include a self-adhesive layer bonded to a side of the fluid impervious film facing away from the textile layer to facilitate fixation of the impervious insulator sheet to the battery cover.

In accordance with another aspect of the disclosure, the self-adhesive layer can be provided as a pressure-sensitive adhesive layer, with a release film releasably bonded to the pressure-sensitive adhesive layer.

In accordance with another aspect of the disclosure, an electric vehicle battery pack mounting arrangement includes a body member, an electric vehicle battery pack, a metal mount bracket disposed between the body member and the electric vehicle battery pack, with a fastener disposed through the body member and through the metal mount bracket into fastened engagement with the electric vehicle battery pack. Further, a multilayer, puncture resistant insulator sheet is disposed between the metal mount bracket and the electric vehicle battery pack. The multilayer, puncture resistant insulator sheet incudes a textile layer having generally planar opposite first and second sides and a fluid impervious film fixed to the first side with an adhesive laminate. The adhesive laminate includes a polymeric film sandwiched between opposite first and second layers of adhesive material. The first layer of adhesive material is bonded to the textile layer and the second layer of adhesive material is bonded to the fluid impervious film.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of an electric motor vehicle with a body removed therefrom to better illustrate a battery pack of the electric motor vehicle;

FIG. 2 is a bottom side perspective view of a multilayer, flexible, impact resistant, impervious, dielectric insulator sheet constructed in accordance with one aspect of the disclosure;

FIG. 3 is a cross-sectional, partial side view of the battery pack with a mounting arrangement mounting the battery pack to a body member of the electric vehicle, and further illustrating the multilayer, flexible, impact and puncture resistant, impervious, dielectric insulator sheet disposed between a mount member of the mounting arrangement and a battery cover of the battery pack;

FIG. 4A is a top plan view of the mounting arrangement including a mount bracket and a pair of the multilayer, flexible, impact and puncture resistant, impervious, dielectric insulator sheets disposed beneath the mount bracket for engagement with the battery cover;

FIG. 4B is a bottom plan view of the mount bracket and the pair of the multilayer, flexible, impact and puncture resistant, impervious, dielectric insulator sheets of FIG. 4A;

FIG. 5 is a schematic cross-sectional view taken generally along the line of FIG. 4A;

FIG. 5A is a schematic cross-sectional view of an adhesive layer used to bond a textile layer to a fluid impervious film of the multilayer, flexible, impact resistant, impervious, dielectric insulator sheets;

FIG. 5B is a schematic fragmentary plan view of the textile layer of the multilayer, flexible, impact resistant, impervious, dielectric insulator sheets;

FIG. 6A is a schematic top view of a battery pack with a mounting arrangement in accordance with the prior art;

FIG. 6B is a view similar to FIG. 3 of the battery pack and mounting arrangement taken generally along the line 6B-6B of FIG. 6A, with the mounting arrangement shown mounting the battery pack to a body member of the electric vehicle in accordance with the prior art; and

FIG. 6C is a schematic illustration similar to FIG. 6B illustrating an impact force deforming the body member and causing the mount bracket of the mounting arrangement penetrating the battery cover and causing a short-circuit against an internal bus bar in accordance with the prior art.

### DETAILED DESCRIPTION OF PREFERRED EMBODIMENTS

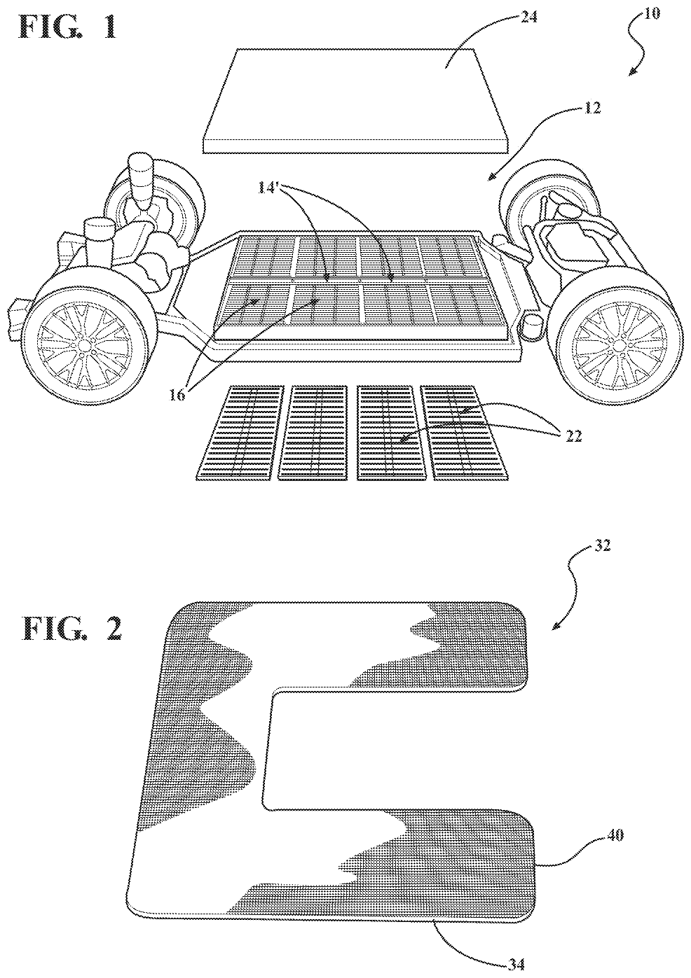

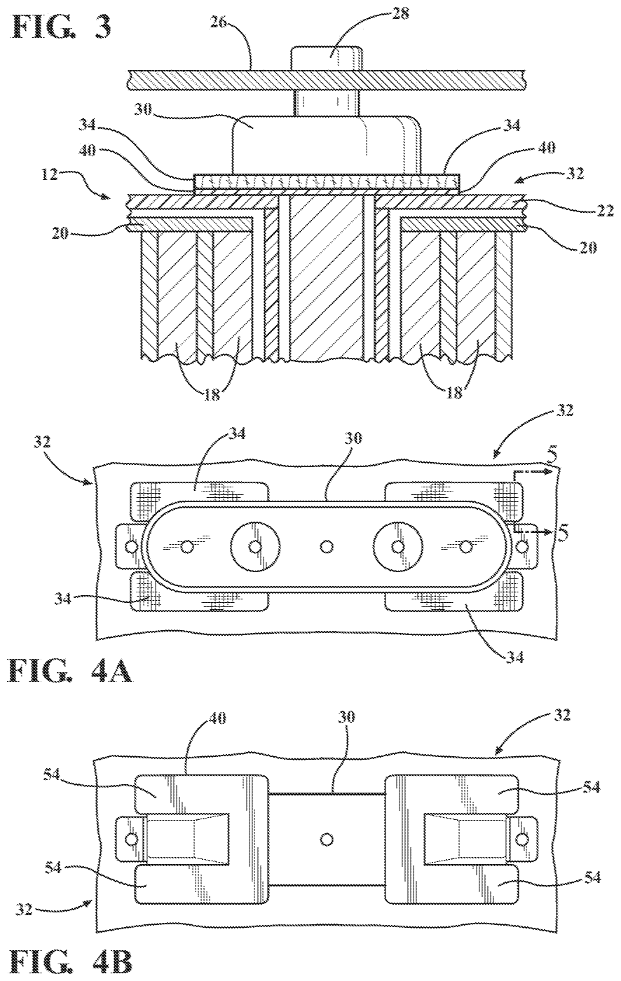

Referring in more detail to the drawings, FIG. 1 illustrates a motor vehicle, shown as an electrically powered motor vehicle, also referred to as electric vehicle 10, having a battery pack 12, such as a lithium-ion battery pack, configured with a multilayer thermal insulator 10 in accordance with an aspect of the invention. The electric vehicle battery pack 12 includes a battery pack housing, referred to hereafter as housing 14, with housing 14 including a plurality of cell module housings 14′, with each cell module housing 14′ bounding a separate battery module 16 including a plurality of cells 18. The cells 18 within each of the battery modules 16 are brought into electrical communication with one another via internal bus bars 20 (FIG. 3), and the cells 18 in adjacent battery modules 16 are brought into electrical communication with one another via external bus bars (now shown). The battery modules 16 can be closed off by module lids 22, and the entirely of the housing 14 can be closed off by a housing lid, also referred to as a battery box lid 24.

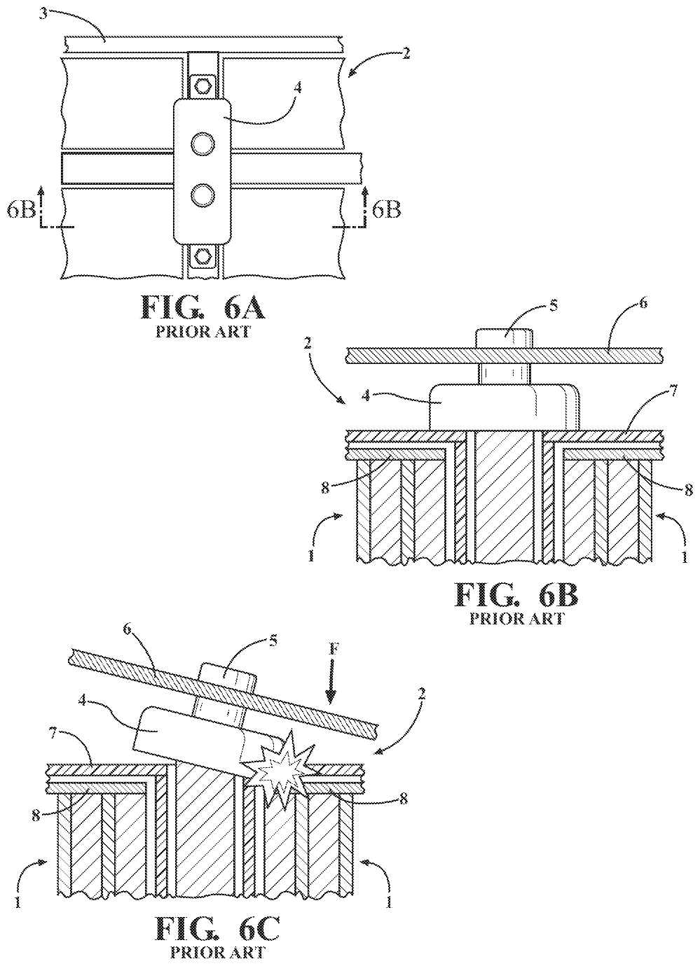

The battery pack 12 is fixed to a frame member or body panel, referred to hereafter as body member 26, of the electric vehicle 10 via a mounting arrangement including at least one or a plurality of fasteners 28 and a metal mount bracket, referred to hereafter as mount bracket 30. Mounting arrangement further includes a multilayer, flexible, impact and puncture resistant, impervious, dielectric insulator sheet, referred to hereafter as protector sheet 32 (FIGS. 2-5), constructed in accordance with the disclosure herein, is disposed between the mount bracket 30 and the battery pack 12. As such, if the mount bracket 30 becomes deformed or otherwise displaced, such as via an impact force F as shown in FIG. 6B, the protector sheet 32 resists puncture and prevents short-circuit from resulting by preventing contact between the mount bracket 30 and the internal bus bars 20 should the module lid 22 and/or battery box lid 24 be penetrated or otherwise damaged. Accordingly, the operable integrity of the battery pack 12 is able to be more likely maintained in a crash condition.

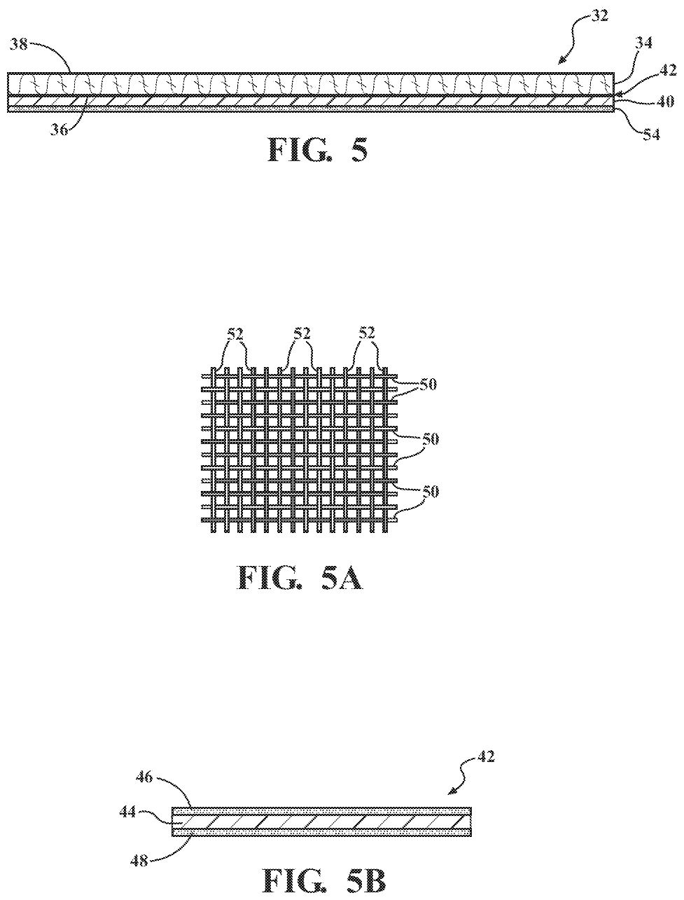

The protector sheet 32 includes a textile layer 34 having generally planar opposite first and second sides 36, 38 (FIG. 5) and a fluid impervious layer, also referred to as fluid impervious film 40 fixed to the first side 36, such as with an adhesive laminate, also referred to as adhesive layer 42. The adhesive layer 42 can be provided as an adhesive laminate (FIG. 5A) including a polymeric film 44 sandwiched between opposite first and second layers 46, 48 of adhesive material, wherein one of said opposite layers, shown as the first layer 46 of adhesive material, is bonded directly to the textile layer 34 and the other of the opposite layers, shown as the second layer 48 of adhesive material, is bonded directly to the fluid impervious film 40. Accordingly, the adhesive layer 42 includes a central, puncture resistant polymeric film 44 with first and second adhesive layers 46, 48 being on opposite sides of the central, puncture resistant polymeric film 44.

The fluid impervious film 40 is a polymeric film, wherein the polymeric film can be formed from polyethylene terephthalate. In accordance with a preferred embodiment, the polyethylene terephthalate film has a gauge between 200-1000 and a dielectric resistance between 5 kV-25 kV. The fluid impervious film 40 functions to prevent the passage of fluid and moisture, thereby preventing a short-circuit between the mount bracket 30, textile layer 34 and the internal bar 20 or other contents of the battery modules 16, including the cells 18. As such, even if the textile layer 34 has a high moisture content, should the respective module lid 22 become damaged and/or penetrated by the mount bracket 30, a short-circuit is prevented by the prevention of fluid/moisture transfer by the fluid impervious film 40.

The textile layer 34, in accordance with one presently preferred aspect, is provided as a woven layer. The woven layer 34, as shown schematically in FIG. 5B, is woven including weft direction multifilament yarn 50 and warp direction multifilament yarn 52. The weft direction multifilament yarn 52 is provided having a denier between 1400 and 2300, and the warp direction multifilament yarn 50 is provided having a denier between 2400 and 3400. The weft direction multifilament yarn 52 is air texturized, and the warp direction multifilament yarn is air texturized and twisted, with the twisting enhancing the strength of the woven layer 34. The woven layer 34 is woven with a densely woven plain weave pattern, which ultimately results in a fabric that is visually devoid of through openings, thus, enhancing it resistance to tear and penetration by debris, while also enhancing the impact resistance of the woven layer 34, which in turn functions to protect the underlying fluid impervious film 40 against damage. The weft direction multifilament yarn 52 and the warp direction multifilament yarn 50 can be provided from polyamide 6, by way of example and without limitation.

To facilitate fixing the protector sheet 32 to the battery box lid 24, a self-adhesive layer 54 can be bonded to a side of the fluid impervious film 40 facing away from the textile layer 54. The self-adhesive layer 54 can be provided as a pressure-sensitive adhesive layer, and a release film (not shown) can be releasably bonded to the pressure-sensitive adhesive layer 54 until desired to expose the pressure-sensitive adhesive layer 54 for adhesion to the battery box lid 24.

The protective sheet 32 is shown as being generally U-shaped to conform to an underside shape and contour of the mount bracket 30, while avoiding interference with the fastener 28. It is to be recognized that other shapes are contemplated herein, as needed to conform to the shape and contour of the chosen mount bracket 30.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A multilayer, flexible, impact and puncture resistant, dielectric insulator sheet for an electric vehicle battery pack, comprising:
a textile layer having generally planar opposite first and second sides; and
a fluid impervious film fixed to said first side with an adhesive laminate including a polymeric film sandwiched between opposite first and second layers of adhesive material, said first layer of adhesive material bonded to said textile layer and said second layer of adhesive material bonded to said fluid impervious film.

2. The multilayer, flexible, impact and puncture resistant, dielectric insulator sheet of claim 1, wherein said fluid impervious film is a polymeric film.

3. The multilayer, flexible, impact and puncture resistant, dielectric insulator sheet of claim 2, wherein said polymeric film is a polyethylene terephthalate film.

4. The multilayer, flexible, impact and puncture resistant, dielectric insulator sheet of claim 3, wherein said polyethylene terephthalate film is between 200-1000 gauge.

5. The multilayer, flexible, impact and puncture resistant, dielectric insulator sheet of claim 3, wherein said polyethylene terephthalate film has between a 5 kV-25 kV dielectric resistance.

6. The multilayer, flexible, impact and puncture resistant, dielectric insulator sheet of claim 1, wherein said textile layer is a woven layer.

7. The multilayer, flexible, impact and puncture resistant, dielectric insulator sheet of claim 6, wherein said woven layer includes weft direction multifilament yarn and warp direction multifilament yarn.

8. The multilayer, flexible, impact and puncture resistant, dielectric insulator sheet of claim 7, wherein said weft direction multifilament yarn has a denier between 1400-2300, and said warp direction multifilament yarn has a denier between 2400-3400.

9. The multilayer, flexible, impact and puncture resistant, dielectric insulator sheet of claim 8, wherein said weft direction multifilament yarn is air texturized, and said warp direction multifilament yarn is air texturized and twisted.

10. The multilayer, flexible, impact and puncture resistant, dielectric insulator sheet of claim 7, wherein said woven layer is woven having a densely woven plain weave pattern.

11. The multilayer, flexible, impact and puncture resistant, dielectric insulator sheet of claim 7, wherein said weft direction multifilament yarn and said warp direction multifilament yarn are polyamide 6.

12. The multilayer, flexible, impact and puncture resistant, dielectric insulator sheet of claim 1, further including a self-adhesive layer bonded to a side of said fluid impervious film facing away from said textile layer.

13. The multilayer, flexible, impact and puncture resistant, dielectric insulator sheet of claim 12, wherein said self-adhesive layer is a pressure-sensitive adhesive layer, and further including a release film releasably bonded to said pressure-sensitive adhesive layer.

14. An electric vehicle battery pack mounting arrangement, comprising:
a body member;
an electric vehicle battery pack;
a metal mount bracket disposed between said body member and said electric vehicle battery pack;
a fastener disposed through said body member and through said metal mount bracket into fastened engagement with said electric vehicle battery pack; and
a multilayer insulator sheet disposed between said metal mount bracket and said electric vehicle battery pack, said multilayer insulator sheet comprising:
a textile layer having generally planar opposite first and second sides; and
a fluid impervious film fixed to said first side with an adhesive laminate including a polymeric film sandwiched between opposite first and second layers of adhesive material, said first layer of adhesive material bonded to said textile layer and said second layer of adhesive material bonded to said fluid impervious film.

15. The electric vehicle battery pack mounting arrangement of claim 14, wherein said fluid impervious film is a polymeric film.

16. The electric vehicle battery pack mounting arrangement of claim 15, wherein said textile layer is a woven layer having weft direction multifilament yarn and warp direction multifilament yarn.

17. The electric vehicle battery pack mounting arrangement of claim 16, wherein said weft direction multifilament yarn has a denier between 1400-2300, and said warp direction multifilament yarn has a denier between 2400-3400.

18. The electric vehicle battery pack mounting arrangement of claim 16, wherein said weft direction multifilament yarn and said warp direction multifilament yarn are polyamide 6.

19. The electric vehicle battery pack mounting arrangement of claim 16, wherein said woven layer is woven having a densely woven plain weave pattern.

20. The electric vehicle battery pack mounting arrangement of claim 14, further including a self-adhesive layer bonded to a side of said fluid impervious film facing away from said textile layer.
